(19) United States
(12) Patent Application Publication
(10) Pub. No.: US 2012/0182685 A1
(43) Pub. Date: Jul. 19, 2012

(54) Data Storage Device

(75) Inventors: Hong-Chi Yu, Kaohsiung City (TW); Mao-Ting Chang, Kaohsiung City (TW)

(73) Assignee: WALTON ADVANCED ENGINEERING INC., Kaohsiung (TW)

(21) Appl. No.: 13/064,399

(22) Filed: Mar. 23, 2011

(30) Foreign Application Priority Data
Jan. 17, 2011 (TW) 100101686

(51) Int. Cl. G06F 1/16

(52) U.S. Cl. 361/679.33

(57) ABSTRACT

A data storage device which allows one user to plug the present invention onto any computer is provided with an integrated circuit module in which a control element's virtual device module can issue a request to the computer and makes the present invention become a virtual device when the integrated circuit module is electrically connected to a memory card module. Accordingly, the present invention developed to be a thin structure conforms to an electronic product's structural style featuring lightness, thinness, shortness, and smallness and delivers information fast transmitted and received by a virtual device, a plurality of data storage devices plugged onto a computer, and multiple types of software simultaneously executed.

### BACKGROUND OF THE INVENTION

1) Field of the Invention

The present invention relates to a data storage device, especially to a data storage device with a virtual device module.

2) Description of the Prior Art

As shown in FIG. 1 and FIG. 2, a data storage device with a USB data transfer interface and a memory card is composed of an insulation base (51), an electric module (52) and a shield case (53) wherein the insulation base (51) is provided with a butting end (511) as well as a groove (512) (opposite to the butting end (511) and prepared to accommodate a memory card (54)) at both ends and an opening (513) at its bottom linking the groove (512).

An electric module (52) comprises a substrate (521) located inside the opening (513) and provided with metal contacts (5211) at its outer surface, which combine the butting end (511) to develop a male connector conforming to the USB data transfer interface, and metal contacts (5212) as well as relevant electronic devices at its inner surface wherein the metal contacts (5212) are electrically connected to a conductive terminal unit (522) used to electrically link contact points (541) of a memory card (54).

A cannular shield case (53) used to cover the opening (513) of the insulation base (51) has a mouth (531) which oppositely holds the groove (512) for development of an opening to accommodate a memory card at one end and is open to metal contacts (5211) for the substrate (521) at the other end of the mouth (531).

The data storage device has space for the memory card (54) plugged into the groove (512). With the butting end (511) of the insulation base (51) plugged into a computer's USB port, the memory card (54) is electrically connected to the contact part (5221) of the conductive terminal unit (522) via contact points (541), and signals from the memory card (54) are transmitted to metal contacts (5212) on an inner surface of the substrate (521), metal contacts (5211) on an outer surface of the substrate (521), and finally the computer through the conductive terminal unit (522). A so-called computer is one machine used to execute a series of commands for data operation under electronics theories. Despite various types of tools used in actual data operation, a computer can be selected from but not limited to one of the following devices such as Mobile Device, PC, Desktop, Tablet PC, server, or Personal Digital Assist (PDA).

The data storage device is designed to develop a structure of a card reader which has a male connector conforming to the USB data transfer interface and combined with a memory card in order to deliver the card reader with a thin structure design. However, the said data storage device taken as a card reader only without a virtual device module built ineffectively enables installed virtual device software.

### SUMMARY OF THE INVENTION

To solve the said issue, the present invention provides a data storage device which comprises an integrated circuit module and at least a memory card module electrically connecting each other wherein the integrated circuit module's control element has a virtual device module issuing a request to a computer for connection to each device among a CD-ROM, a hard drive, and a floppy disk.

Accordingly, the principal object of the present invention is to provide a data storage device with a thin structure conforming to lightness, thinness, shortness, and smallness required in one electronic product.

The additional object of the present invention is to provide a data storage device in which an integrated circuit module's control element has a virtual device module issuing a request to a computer for connection to each device among a CD-ROM, a hard drive, and a floppy disk and deliver multiple advantages such as information fast transmitted and received by a virtual device, a plurality of data storage devices plugged onto a computer, and different types of software simultaneously executed.

To this end, the present invention has the principal technical measures delivered with the following techniques. The present invention is a data storage device electrically connected to a computer and comprising an integrated circuit module and at least a memory card module wherein the integrated circuit module comprises at least a control element adhered to a substrate which has an inner surface and an outer surface provided with a plurality of metal contacts electrically connected to the computer; the memory card module comprises at least a memory chip and a control element collectively adhered to a substrate wherein the substrate has an inner surface and an outer surface provided with a plurality of metal contacts electrically connected to a plurality of metal contacts on an inner surface of the substrate in the integrated circuit module and the memory chip has at least a storage space; the integrated circuit module's control element has a virtual device module which can issue a request to a computer for connection to each device among a CD-ROM, a hard drive, and a floppy disk.

The purposes and the technical issues with respect to the present invention are further embodied with the following technical measures.

In the said data storage device, the metal contacts on an outer surface of the substrate in the integrated circuit module are compatible to a male connector with at least one of the following data transfer interfaces such as Universal Serial Bus (USB), Mini Universal Serial Bus (Mini USB), or Micro Universal Serial Bus (Micro USB).

In the said data storage device, the control element has a storage space adjustment module used to adjust capacity of a storage space of a memory chip in the memory card module.

In the said data storage device, the storage space of the memory chip in the memory card module can be taken as a storage space for general data accessed, saved, or deleted by one user.

In the said data storage device, the storage space of the memory chip in the memory card module through the control element can be set to each virtual device among a CD-ROM, a hard drive, and a floppy disk.

In the said data storage device, the storage space of the memory chip in the memory card module is used to save built-in files and/or programs.

In the said data storage device, the metal contacts of the memory card module are compatible to the protocol of at least one memory card format such as SD (Secure Digital Card), miniSD, microSD, MMC and xD.

In the said data storage device, the metal contacts (1121) on the outer surface (112) of the substrate (11) in the integrated circuit module (10) are exposed on a case (30).

In the said data storage device, the memory card module (20) is a separate plug-in module.

In the said data storage device, a package body (14) is used to encase the control element (13) of the integrated circuit module (10) and the memory chip (22) as well as the control element (23) of the memory card module (20).

Compared with the prior arts, the present invention is characteristic of a thin structure conforming to lightness, thinness, shortness and smallness required in an electronic product, information fast transmitted and received by a virtual device, a plurality of data storage devices plugged onto a computer, and multiple types of software simultaneously executed.

### BRIEF DESCRIPTIONS OF THE DRAWINGS

FIG. 1 is the perspective exploded view of a data storage device manufactured in the prior arts.

FIG. 2 is the external perspective view prior to a memory card plugged into a data storage device, which is manufactured in the prior arts.

FIG. 3 is the perspective view in the first embodiment for the present invention of a data storage device.

FIG. 4 is the sectional view of the memory module in the first embodiment for the present invention of a data storage device.

FIG. 5 is the sectional view of the memory card module in the first embodiment for the present invention of a data storage device.

FIG. 6 is the block diagram in the first embodiment for the present invention of a data storage device.

FIG. 7 is the schematic diagram in the first embodiment for the present invention of a data storage device plugged into a computer's port.

FIG. 8 is the sectional view of the package body encasing the memory card module in the first embodiment for present invention of a data storage device.

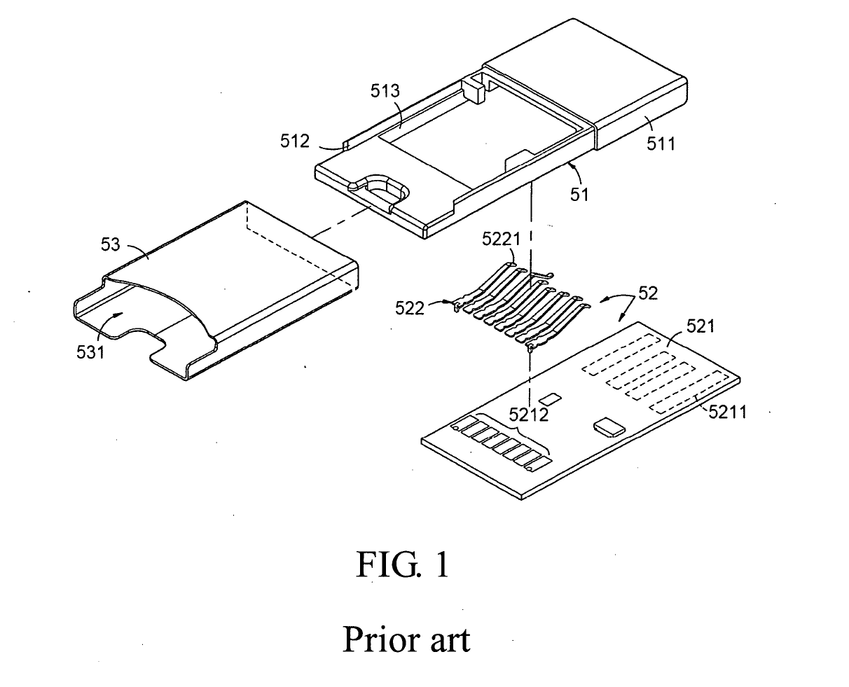

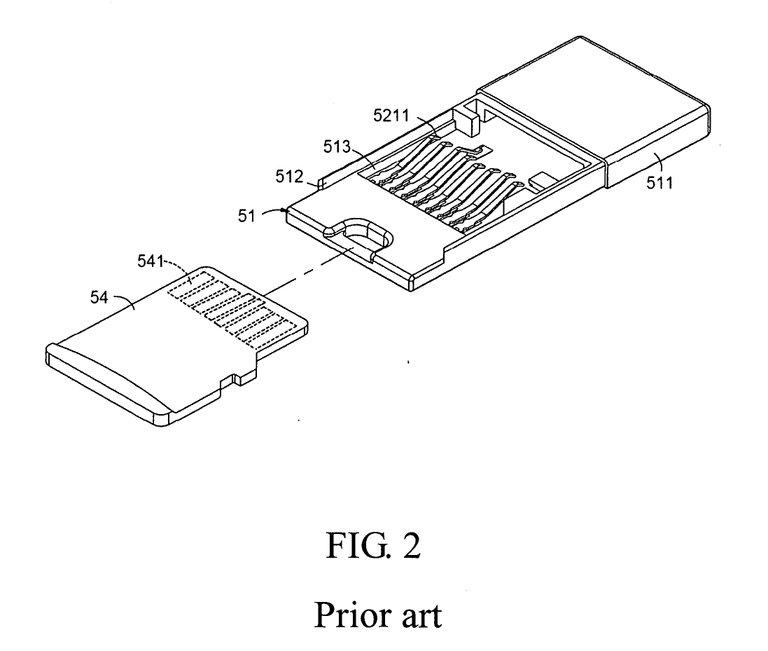

### DETAILED DESCRIPTIONS OF THE PREFERRED EMBODIMENTS

For objects, characteristics, and effects obviously and easily understood, the preferred embodiments of the present invention are particularly interpreted as follows:

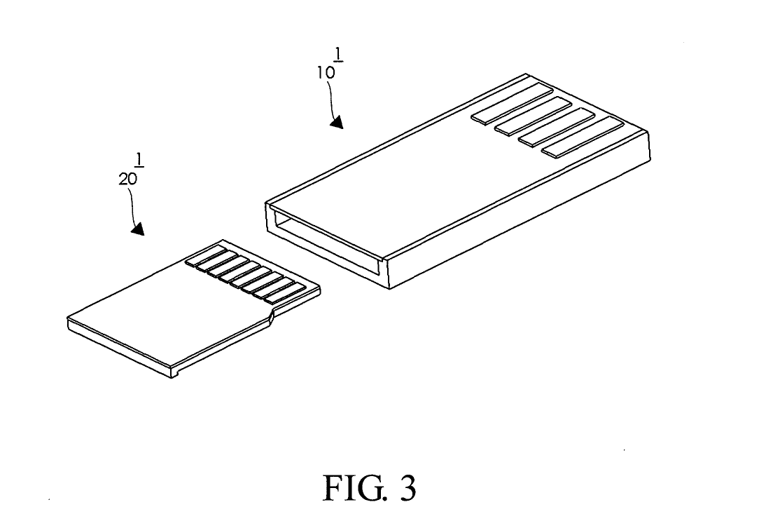

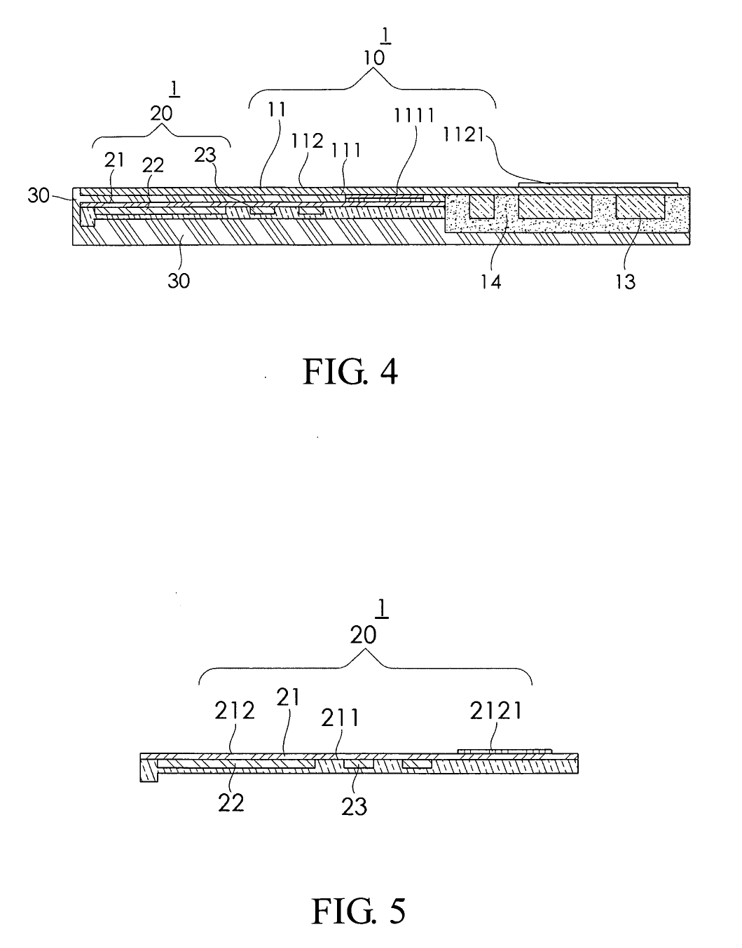

The first embodiment for the present invention of a data storage device (1) is shown from FIG. 3 to FIG. 8. Referring to FIGS. 3 and 4 first which indicate the present invention is electrically connected to a computer and comprises an integrated circuit module (10) and at least a memory card module (20).

The integrated circuit module (10) comprises at least a control element (13) adhered to a substrate (11) wherein the substrate (11) has an inner surface (111) and an outer surface (112) provided with a plurality of metal contacts (1121) electrically connected to a computer.

The substrate (11) is usually a high-density double-sided multi-layer printed circuit board with circuits (not shown in figures) developed inside as an interface for transmit of electricity and the metal contacts (1121) electrically connected to the memory chip (12) and the control element (13) via the substrate (11).

The metal contacts (1121) on the outer surface (112) of the substrate (11) in the integrated circuit module (10) are compatible to a male connector with at least one of the following data transfer interfaces such as Universal Serial Bus (USB), Mini Universal Serial Bus (Mini USB), or Micro Universal Serial Bus (Micro USB). The metal contacts (1121) in this embodiment are described with a male connector (Series A) compatible to the Universal Serial Bus (USB) data transfer interface.

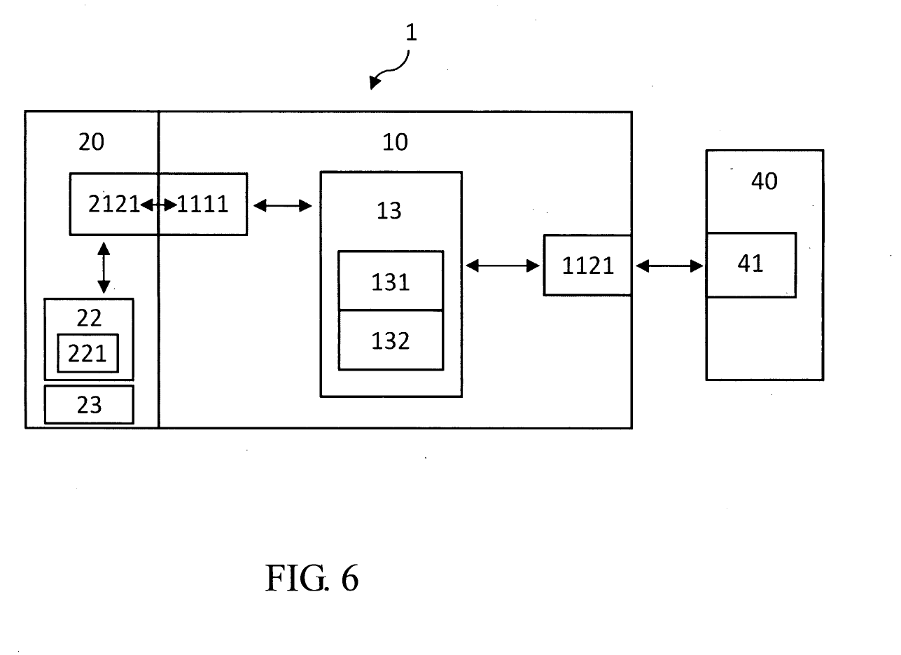

Referring to FIG. 5 which indicates the memory card module (20) comprises at least a memory chip (22) and a control element (23) adhered to a substrate (21) wherein the substrate (21) has an inner surface (211) and an outer surface (212) provided with a plurality of metal contacts (2121) and the memory chip (22) has at least a storage space (221) (FIG. 6).

Specifically, the substrate (21) is usually a high-density double-sided multi-layer printed circuit board with circuits (not shown in figures) developed inside as an interface for transmit of electricity and the metal contacts (1121) electrically connected to the memory chip (22) and the control element (23) via the substrate (21).

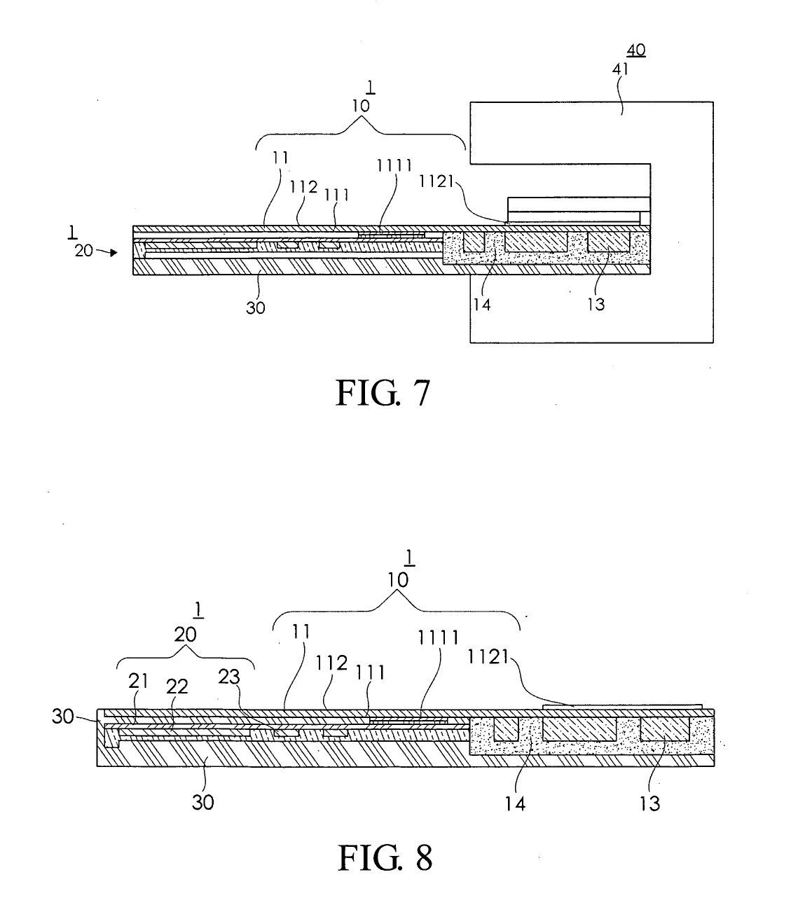

Referring to FIGS. 5 and 7 which indicate the metal contacts (2121) are electrically connected to a plurality of metal contacts (1111) on the inner surface (111) of the substrate (11) in the integrated circuit module (10).

Preferably, the metal contacts (2121) of the memory card module (20) are compatible to the protocol of at least one memory card format such as SD (Secure Digital Card), miniSD, microSD, MMC and xD.

Referring to FIG. 6 again which indicates the control element (13) in the integrated circuit module (10) has a virtual device module (132) that can issue a request to a computer (40) for connection to each device among a CD-ROM, a hard drive, and a floppy disk (for instance, a virtual CD-ROM in this embodiment).

Referring to FIGS. 6 and 7 which indicate metal contacts (1121) in the integrated circuit module (10) (for instance, a male connector with a USB data transfer interface in this embodiment) are plugged into a corresponding data transfer interface, port (41) on the computer (40), and a request of connecting a CD-ROM is issued to the computer (40) by the virtual device module (132) as per a device determined by the computer (40) (USB device in this embodiment).

In the present invention, the storage space (221) of the memory chip (22) in the memory card module (20) includes but is not limited to a storage space with general data accessed, saved, or deleted by one user; the storage space through the control element (13) can be set to each virtual device among a CD-ROM, a hard drive, and a floppy disk (a virtual CD-ROM in this embodiment) wherein the virtual device comprises an automatic executive file (e.g., Autorun.inf) or an application program such as built-in file or program to be driven or executed (e.g., Setup.exe) or is used to save the built-in file and/or program.

Specifically, a so-called built-in file and/or program includes but is not limited to an image, a photo, a text file, a protection utility, a service utility, software, a software driver or an autorun utility.

Referring to FIGS. 6 and 7 which indicate the control element (13) in the integrated circuit module (10) has a storage space adjustment module (131) preferably used to adjust capacity of partitioned sections in the storage space (221) of the memory card module (20). Preferably, the storage space adjustment module (131) displayed in an interface (or a window) can be automatically executed and allow a user to change memory capacity of partitioned sections in a storage space when the device is plugged into the port (41) of the computer (40).

Preferably, referring to FIG. 7 which indicates the metal contacts (1121) on the outer surface (112) of the substrate (11) in the integrated circuit module (10) are exposed on a case (30) and the memory card module (20) is a separate plug-in module.

Referring to FIG. 8 which indicates the inner surface (111) on the substrate (11) in the integrated circuit module (10) is developed to a package body (14) encasing the control element (13) of the integrated circuit module (10) and the memory chip (22) as well as the control element (23) of the memory card module (20).

The present invention is provided with a data storage device which allows the present invention to be plugged onto any computer by one user and become a virtual device with the integrated circuit module electrically connected to the memory card module and a request issued to a computer by the virtual device module of the integrated circuit module's control element. Accordingly, the present invention with a thin structure delivers information fast transmitted and received, a plurality of data storage devices plugged onto a computer, and effects of different types of software simultaneously executed.

The present invention that is different from general conventional data storage devices and referred to as creative work among similar products meets patentability and is applied for the patent.

It must be stressed that the said descriptions are only the preferred embodiments of the present invention and any equivalent change in descriptions, claims, or drawings of the present invention is under protection of the technical scope of the present invention which accordingly depends on claims specified hereinafter.

What is claimed is:

1. A data storage device (1) electrically connected to a computer, comprising:
An integrated circuit module (10) comprises at least a control element (13) adhered to a substrate (11) which has an inner surface (111) and an outer surface (112) provided with a plurality of metal contacts (1121) for electrical connection to the computer;
At least a memory card module (20) comprises at least a memory chip (22) and a control element (23) adhered to a substrate (21) wherein the substrate (21) has an inner surface (211) and an outer surface (212) provided with a plurality of metal contacts (2121) for electrical connection to a plurality of metal contacts (1111) on the inner surface (111) of the substrate (11) in the integrated circuit module (10) and the memory chip (22) has at least a storage space (221);
The control element (13) in the integrated circuit module (10) has a virtual device module (132) which issues a request to a computer for connection to each device among a CD-ROM, a hard drive, and a floppy disk.

2. The data storage device (1) according to claim 1 wherein the metal contacts (1121) on the outer surface (112) of the substrate (11) in the integrated circuit module (10) are compatible to a male connector with at least one of the following data transfer interfaces such as Universal Serial Bus (USB), Mini Universal Serial Bus (Mini USB), or Micro Universal Serial Bus (Micro USB).

3. The data storage device (1) according to claim 1 wherein the control element (13) has a storage space adjustment module (131) used to adjust capacity of the storage space (221) of the memory chip (22) in the memory card module (20).

4. The data storage device (1) according to claim 1 wherein the storage space (221) of the memory chip (22) in the memory card module (20) is a storage space with general data accessed, saved, and deleted by one user.

5. The data storage device (1) according to claim 1 wherein the storage space (221) of the memory chip (22) in the memory card module (20) through the control element (13) can be set to each virtual device among a CD-ROM, a hard drive, and a floppy disk.

6. The data storage device (1) according to claim 1 wherein the storage space (221) of the memory chip (22) in the memory card module (20) is used to save a built-in file and/or a program.

7. The data storage device (1) according to claim 1 wherein the metal contacts (2121) of the memory card module (20) are compatible to the protocol of at least one memory card format such as SD (Secure Digital Card), miniSD, microSD, MMC and xD.

8. The data storage device (1) according to claim 1 wherein the metal contacts (1121) on the outer surface (112) of the substrate (11) in the integrated circuit module (10) are exposed on a case (30).

9. The data storage device (1) according to claim 1 wherein the memory card module (20) is a separate plug-in module.

10. The data storage device (1) according to claim 1 wherein a package body (14) is used to encase the control element (13) of the integrated circuit module (10) and the memory chip (22) as well as the control element (23) of the memory card module (20).
